(19) United States
(12) Patent Application Publication
(10) Pub. No.: US 2023/0099350 A1
(43) Pub. Date: Mar. 30, 2023

(54) BATTERY MODULE, A BATTERY PACK, AN ELECTRIC VEHICLE, A BATTERY MANAGEMENT ARRANGEMENT, AND A METHOD FOR ASSEMBLING A BATTERY MODULE

(71) Applicant: SAMSUNG SDI CO., LTD., Yongin-si (KR)

(72) Inventors: Markus RIDISSER, Premstätten (AT); Bernhard HADLER, Feldkirchen/Graz (AT)

(21) Appl. No.: 17/953,197

(22) Filed: Sep. 26, 2022

(30) Foreign Application Priority Data
Sep. 28, 2021 (EP) 21199478.5
Sep. 23, 2022 (KR) 10-2022-0120905

(51) Int. Cl. H01M 10/42; H01M 50/224; H01M 50/262; H01M 50/258

(52) U.S. Cl. CPC H01M 10/4257; H01M 50/224; H01M 50/262; H01M 50/258; H01M 2010/4271; H01M 2220/20; H01M 50/249

(57) ABSTRACT

A battery module includes: a housing including a removable housing section; a plurality of battery cells accommodated within the housing; and a battery management arrangement. The battery management arrangement includes: a battery management module (BMM); a battery management housing including a bracket configured to retain the BMM; and an electronics arrangement. The battery management housing is in the housing and arranged between two of the battery cells.

### CROSS-REFERENCE TO RELATED APPLICATION

This application claims priority to and the benefit of European Patent Application No. 21199478.5, filed in the European Patent Office on Sep. 28, 2021, and Korean Patent Application No. 10-2022-0120905, file in the Korean Intellectual Property Office on Sep. 23, 2022, the entire content of both of which are incorporated herein by reference.

### BACKGROUND

### 1. Field

Aspects of embodiments of the present disclosure relate to a battery module for an electric vehicle, a battery pack including the battery module, an electric vehicle including the battery pack, a battery management arrangement for the battery module, and a method for assembling the battery module.

### 2. Description of the Related Art

Recently, vehicles for transportation of goods and people have been developed that using electric power as a source for motion. Such an electric vehicle is an automobile that is propelled by an electric motor using energy stored in rechargeable batteries. An electric vehicle may be solely powered by batteries or may be a hybrid vehicle powered by, for example, a gasoline generator or a hydrogen fuel power cell. Furthermore, the vehicle may include a combination of an electric motor and a conventional combustion engine.

Generally, an electric-vehicle battery (EVB or traction battery) is a battery used to power the propulsion of battery electric vehicles (BEVs). Electric-vehicle batteries differ from starting, lighting, and ignition batteries because they are designed to provide power for sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supply for small electronic devices, such as cellular phones, notebook computers, and camcorders, while high-capacity rechargeable batteries are used as the power supply for electric and hybrid vehicles and the like.

Rechargeable batteries may be used as a battery module formed of a plurality of unit battery cells coupled to each other in series and/or in parallel to provide higher energy content, such as for motor driving of a hybrid vehicle. The battery module is formed by interconnecting the electrode terminals of the plurality of unit battery cells depending on a desired amount of power and to realize a high-power rechargeable battery.

Battery modules can be constructed either in block design or in modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems often consist of a plurality of battery modules connected to each other in series to provide a desired voltage. Therein, the battery modules may include submodules with a plurality of stacked battery cells, with each stack includes cells connected in parallel that are, in turn, connected in series (XpYs) or cells connected in series that are, in turn, connected in parallel (XsYp).

A battery pack is a set of any number of (usually identical) battery modules. They may be configured in a series, parallel, or a mixture of both to deliver the desired voltage, capacity, and/or power density. Components of battery packs include the individual battery modules and the interconnects, which provide electrical conductivity between the battery modules.

A battery system further includes a battery management system (BMS), which is an electronic system that manages the rechargeable battery, battery module, and battery pack, such as by protecting the batteries from operating outside their safe operating area (or operating parameters), monitoring their states, calculating secondary data, reporting that data, controlling an environment, authenticating it, and/or balancing it. For example, the BMS may monitor the state of the battery as represented by voltage (such as total voltage of the battery pack or battery modules, or voltages of individual cells), temperature (such as average temperature of the battery pack or battery modules, coolant intake temperature, coolant output temperature, or temperatures of individual cells), coolant flow (such as flow rate and/or cooling liquid pressure), and current. Additionally, a BMS may calculate values based on the above items, such as minimum and maximum cell voltage, state of charge (SoC), or depth of discharge (DoD) to indicate the charge level of the battery, state of health (SoH; a variously-defined measurement of the remaining capacity of the battery as % of the original capacity), state of power (SoP; the amount of power available for a defined time interval given the current power usage, temperature and other conditions), state of safety (SoS), maximum charge current as a charge current limit (CCL), maximum discharge current as a discharge current limit (DCL), and internal impedance of a cell (to determine open circuit voltage).

The BMS may be centralized such that a single controller is connected to the battery cells through a plurality of wires. The BMS may be also distributed, with a BMS board installed at each cell and only a single communication cable between the battery and a controller. Or the BMS may be of modular construction including a few controllers, each handling a certain number of (e.g., a subset of) cells, with communication between the controllers. Centralized BMSs are most economical but are least expandable and are plagued by a multitude of wires. Distributed BMSs are the most expensive but are simplest to install and offer the cleanest assembly. Modular BMSs offer a compromise of the features and problems of the other two topologies.

A BMS may protect the battery pack from operating outside its safe operating area (or operating parameters). Operation outside the safe operating area may be indicated by an over-current, over-voltage (e.g., during charging), over-temperature, under-temperature, over-pressure, and ground fault or leakage current detection. The BMS may prevent operation outside the battery's safe operating area by including an internal switch, such as a relay or solid-state device, which opens if the battery is operated outside its safe operating area, requesting the devices to which the battery is connected to reduce or even terminate using the battery, and actively controlling the environment, such as through heaters, fans, air conditioning, or liquid cooling.

The mechanical integration of such a battery system involves appropriate mechanical connections between the individual components, for example, between battery cells, the BMS, and the housing. These connections should remain functional and safe during the average service life of the battery system. Further, installation space and interchangeability requirements must be met, especially in mobile applications.

Battery systems according to the related art, despite any modular structure, usually include a battery housing that acts as enclosure to seal the battery system against the environment and to provide structural protection of the battery system's components. Housed battery systems are usually mounted as a whole into their application environment (e.g. an electric vehicle). Thus, the replacement of defect system parts, such as a defect battery submodule, requires dismounting the whole battery system and removal of its housing first. Even defects in small and/or cheap system parts might then lead to dismounting and replacement of the complete battery system and its separate repair. As high-capacity battery systems are expensive, large, and heavy, such a procedure is burdensome and the storage, such as in the mechanic's workshop, of the bulky battery systems becomes difficult.

A static control of battery power output and charging may not be sufficient to meet the dynamic power demands of various electrical consumers connected to the battery system. Thus, steady exchange of information between the battery system and the controllers of the electrical consumers may be employed. This information includes the battery system's actual state of charge (SoC), potential electrical performance, charging ability, and internal resistance as well as actual or predicted power demands or surpluses of the consumers. Therefore, battery systems usually include a battery management system (BMS) for obtaining and processing such information on a system level and further include a plurality of battery management modules (BMMs), which are part of the system's battery modules and obtain and process relevant information on a module level. The BMS usually measures the system voltage, the system current, the local temperature at different places inside the system housing, and the insulation resistance between live components and the system housing. And the BMMs usually measure the individual cell voltages and temperatures of the battery cells in a battery module.

Thus, the BMS/BMU is provided to manage the battery pack, such as by protecting the battery from operating outside its safe operating area, monitoring its state, calculating secondary data, reporting that data, controlling its environment, authenticating it and/or balancing it.

Exothermic decomposition of cell components may lead to a so-called thermal runaway. Generally, thermal runaway describes a process that is accelerated by increased temperature, in turn releasing energy that further increases temperature. Thermal runaway occurs in situations where an increase in temperature changes the conditions (e.g., the internal conditions of the cell) in a way that causes a further increase in temperature, often leading to a destructive result. In rechargeable battery systems, thermal runaway is associated with strongly exothermic reactions that are accelerated by temperature rise. These exothermic reactions include combustion of flammable gas compositions within the battery pack housing. For example, when a cell is heated above a critical temperature (typically above about 150° C.), it can transit (or transition) into a thermal runaway. The initial heating may be caused by a local failure, such as a cell internal short circuit, heating from a defect electrical contact, or short circuit with a neighboring cell. During the thermal runaway, a failed battery cell (e.g., a battery cell which has a local failure) may reach a temperature exceeding about 700° C. Further, large quantities of hot gas are ejected from inside the failed battery cell through a vent (e.g., a venting opening) in the cell housing into the battery pack. The main components of the vented gas are H₂, CO₂, CO, electrolyte vapor, and other hydrocarbons. The vented gas is therefore flammable and potentially toxic. The vented gas also causes a gas-pressure increase inside the battery pack.

According to related art, the one or more BMSs are difficult to access in case of failure or service. A repair of electronic components of electric batteries is often linked to a disassembly of the battery. The BMSs consume viable packaging space, generally on top of battery stacks, where they consume significant space in a direction along an elongation (or height) of the battery cells. BMSs generally cannot be placed onto the side of prismatic cells without being potentially damaged caused by swelling forces. Usually packaged close to the battery cells, BMSs are also exposed to high temperature in case of a thermal event and, therefore, the function can be compromised.

In the related art, a cell monitoring unit may be treated like an individual cell during assembly. If, for example, the cell monitoring unit with its further housing is arranged centrally with respect to the cell block, the cell monitoring unit can be regarded as a so-called module divider. But in the event of damage and/or replacement, half, that is, either the individual cells arranged to the left or to the right of the cell monitoring unit, must be removed. Thus, in the related art, to remove the cell monitoring unit, for example, for maintenance and/or service, a plurality of individual cells typically need to be removed.

### SUMMARY

The present disclosure is defined by the appended claims and their equivalents. Any disclosure lying outside the scope of the appended claims and their equivalents is intended for illustrative as well as comparative purposes.

According to one embodiment of the present disclosure, a battery module includes: a housing including a removable housing section; a plurality of battery cells accommodated within the housing; and a battery management arrangement. The battery management arrangement includes: a battery management module (BMM); a battery management housing including a bracket configured to retain the BMM, the battery management housing being arranged within the housing and arranged between two of the battery cells; and an electronics arrangement.

According to another embodiment of the present disclosure, a battery pack includes a plurality of the battery modules as described above.

Another embodiment of the present disclosure provides an electric vehicle including at least one battery module as described above and/or at least one battery pack as described above.

Yet another embodiment of the present disclosure provides a battery management arrangement including: a battery management module (BMM); a battery management housing including a bracket adapted to retain the BMM; and an electronics arrangement.

Yet another embodiment of the present disclosure provides a method for assembling the battery module as described above. The method includes the steps of: a) providing a housing including a removable housing section; a plurality of battery cells accommodated within the housing; and a battery management arrangement including a battery management module (BMM), a battery management housing, an electronics arrangement, and a bracket; b) arranging the battery management housing within the housing and between at least two of the plurality of battery cells; and c) arranging the BMM in the bracket arranged within the battery management housing and adapted to retain the BMM.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings in which:

FIG. 1 is a schematic view of an electric vehicle according to an embodiment.

FIG. 2 is a schematic sectional view of a battery module according to an embodiment.

FIG. 3 is an exploded view of a battery management arrangement according to an embodiment.

FIG. 4 is a sectional side view of a battery management arrangement according to an embodiment.

FIG. 5 is a perspective view of an encasing in an open state and including a battery management module according to an embodiment.

FIG. 6 is a perspective view of the encasing shown in FIG. 5 in a closed state and including a battery management module according to an embodiment.

FIG. 7 is a perspective view of battery management arrangement according to an embodiment.

FIG. 8 is a perspective view of battery management arrangement in the mounted state according to an embodiment.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. In the drawings, like reference numerals denote like elements, and redundant descriptions thereof may be omitted.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of,” when preceding a list of elements, modify the entire list of elements and do not modify the individual elements of the list. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

According to one embodiment of the present disclosure, a battery module includes a housing with a removable housing section, a plurality of battery cells accommodated within the housing, and a battery management arrangement. The battery management arrangement is arranged within the housing.

The battery management arrangement includes a battery management module (BMM), a battery management housing provided within the housing of the battery module and provided between at least two of the plurality of battery cells, and an electronics arrangement. The plurality of battery cells forms a stack. By providing the battery management housing between at least two of the battery cells, the battery management arrangement is arranged in the stack. In some embodiments, each of the plurality of battery cells has a similar shape, and the battery management housing has a shape that is similar to the shape of battery cells so that stacking is facilitated. The battery management housing is a thermal resistant housing in which the BMM is placed (or accommodated) and which protects the BMM from thermal damage in the event of a thermal event and may prolong or even stop a possible thermal runaway. The battery management housing provides a mechanically robust housing to encase the BMM that can sustain (or withstand) forces due to swelling and/or pressing. The electronics arrangement enables the battery management arrangement to collect battery cell sensing lines that are electrically connected to the battery cells of the battery module.

The battery management arrangement further includes a bracket arranged within the battery management housing and configured to retain the BMM. The bracket increases the thermal resistance of the battery management arrangement to further protect the BMM from thermal damage. Due to a sufficient mechanical strength of the battery management housing and/or of the bracket, the BMM can be placed in a swelling direction (e.g., a stacking direction) of the battery cells, which provides new and increased options for stacking and packaging to assemble the battery module. The battery management arrangement can sustain forces caused by swelling and/or pressing due to stacking. The battery management arrangement is arranged within the housing of the battery module so that the BMM can be removed when the removable housing section is removed. This facilitates servicing the battery module. To change (or access) the BMM, only the removable housing section needs to be removed, and therefore, disassembly (or separation) of the battery from the vehicle is not necessary for service purposes. Instead, the BMM can be removed and serviced while the battery remains in the vehicle. Thus, the battery management arrangement becomes a multifunctional super spacer for thermal and electrical insulation with an integrated BMM.

According to one embodiment, the battery management arrangement further includes an encasing removably arranged within the bracket and configured to retain the BMM. Such an embodiment further facilitates the efficient disassembly and assembly of the battery management arrangement. Further, the thermal resistance and mechanical strength of the battery management housing and/or the bracket are unaffected by disassembly or assembly of the battery management system because the encasing can be removed. In some embodiments, the encasing is an insulating plastic encasing, which provides a lightweight, cost-effective encasing and electrical insulation to protect the retained BMM.

According to one embodiment, the encasing includes a plurality of (e.g., two) encasing sections between which the BMM is arranged and/or the encasing includes at least one encasing fastener and/or encasing clip arrangement to removably fasten the encasing to the bracket. The encasing sections form at least a two-part encasing, in which the BMM is arranged. In some embodiments, the encasing can be opened and closed in an optionally reversible manner to enable effective and efficient assembly and, optionally, so that the BMM can be easily removed. For example, the encasing may include a clip arrangement that enables opening the encasing by separating the encasing sections and/or closing the encasing by engaging the encasing sections with each other. In an embodiment in which the encasing includes two encasing sections, the encasing may be referred to as bipartite. The encasing fastener may be a screw arrangement, for example, an encasing opening (or through-hole) formed by the encasing, a bracket opening (or bracket hole) formed by the bracket, and a screw provided so that the encasing can be screwed to the bracket to enable an effective assembly and so that the encasing can be easily removed. Alternatively or additionally, the encasing fastener may include an encasing clip arrangement so that the encasing can be clipped to the bracket.

According to one embodiment, the electronics arrangement is mounted to the bracket to provide mechanical and electrical separation from the electronics arrangement and the battery management housing. The arrangement of the electronics arrangement on the bracket facilitates electrical connection between the electronics arrangement and the battery cells of the battery module and/or between the electronics arrangement and an electronics arrangement of a different battery module.

According to one embodiment, the battery management housing includes (or is made of) metal and the bracket includes (or is made of) a polymer. In such an embodiment, the battery management housing has greater mechanical strength and the bracket is electrically isolating and lightweight.

According to one embodiment, the battery management housing is made of sheet metal with a thickness in a range of about 1.8 mm to about 2.2 mm, such as about 2 mm. This thickness range provides a balance between mechanical strength and weight.

According to one embodiment, the battery management housing defines an axis along which the bracket is slidably insertable in the battery management housing to enable an efficient and simple method of manufacturing the battery management arrangement.

According to one embodiment, the bracket defines an axis along which the BMM is slidably insertable in the bracket to be retained to enable an efficient and simple method of assembling and/or disassembling the bracket and the BMM.

According to one embodiment, the axis is perpendicular to a longitudinal direction of the removable housing section, enabling the bracket and/or the BMM to be efficiently removed if the removable housing section is removed.

According to one embodiment, the bracket has an opening to retain the BMM. The BMM can be inserted into the opening. In some embodiments, the BMM can be inserted into the opening by inserting the encasing together with the BMM into the opening. Therein, the opening is configured to retain the encasing.

According to one embodiment, the bracket includes a connector casing, and the BMM includes a connector provided within the connector casing to interconnect the BMM and the electronics arrangement. In such an embodiment, the connector casing (e.g., the plug housing for a plug for the interconnection between the BMM and the electronics arrangement) is provided by the bracket. Thus, a separate connector casing may be omitted, which provides a cost-efficient design. The connector is formed by the BMM and encased in the connector casing.

According to another embodiment of the present disclosure, a battery pack includes a plurality of battery modules as described above. For example, the battery pack includes a plurality of battery modules with the battery management arrangement as described above, and the battery modules and/or the battery management arrangements are interconnected with each other. The plurality of battery management arrangements that are interconnected with each other are part of, or form, the battery management system.

Yet another embodiment of the present disclosure is an electric vehicle including one or more battery modules as described above and/or one or more battery packs as described above. In other words, the electric vehicle also includes the battery management arrangements as described above. Therein, the battery module and/or the battery pack can be serviced without being removed from the electric vehicle by removing the removable housing section and removing the BMM from the battery management arrangement.

Yet another embodiment of the present disclosure is a battery management arrangement including a battery management module (BMM), a battery management housing, and an electronics arrangement. The battery management arrangement further includes a bracket arranged within the battery management housing and configured to retain the BMM. Such an embodiment relates to the battery management arrangement with its battery management housing, for example, with a so-called super spacer, and provides a battery management arrangement that can be efficiently serviced even when it is mounted in a battery module, in a battery module mounted in the battery pack, and/or in a battery module mounted to an electric vehicle. The battery management arrangement may include optional features as describe above with reference to the battery module.

Yet another embodiment of the present disclosure provides a method for assembling a battery module as described above. The method includes the steps of: a) providing a housing including: a removable housing section; a plurality of battery cells accommodated within the housing; and a battery management arrangement including a battery management module (BMM), a battery management housing, an electronics arrangement, and a bracket; b) arranging the battery management housing within the housing of the battery module between at least two of the plurality of battery cells; and c) arranging the BMM in the bracket arranged within the battery management housing and configured to retain the BMM. This embodiment provides an efficient method of assembly for a battery module due to the efficient arrangement of the BMM within the battery management housing, in which the battery management housing can efficiently be arranged, such as stacked, with the battery cells. At least steps b) and c) of the method are interchangeable.

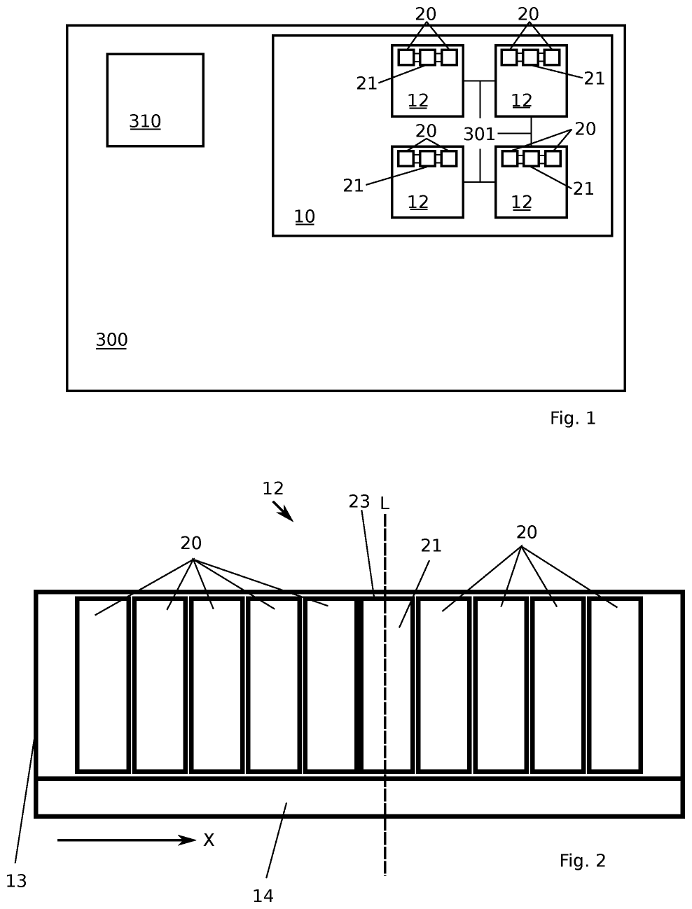

FIG. 1 is a schematic illustration of an electric vehicle 300. The electric vehicle 300 is propelled by an electric motor 310 using energy stored in rechargeable batteries arranged in a battery pack 10. The battery pack 10 is a set of any number of battery modules 12. Rechargeable batteries are used as (or are included in) the battery module 12, which is formed of a plurality of secondary battery cells 20. The battery pack 10 includes the individual battery modules 12 and interconnects 301, which provide electrical conductivity between the battery modules 12.

Each of the battery modules 12 includes a battery management arrangement 21 provided between two (e.g., two adjacent or directly adjacent ones) of the battery cells 20. In this schematic illustration, each battery module 12 includes two battery cells 20 with the battery management arrangement 21 arranged therebetween. However, each of the battery modules 12 can include any number of battery cells 20, for example, as illustrated in FIG. 2 and described with reference thereto. The battery management arrangement 21 is further described with reference to FIGS. 2 to 4 and provides the possibility of an efficient servicing of any of the battery management arrangements 21 without removing the battery pack 10 and/or one of the battery modules 12 from the electric vehicle 300.

FIG. 2 is a schematic sectional view of the battery module 12 according to an embodiment.

The battery module 12 includes a plurality of battery cells 20. The battery cells 20 are arranged in a stacked manner (or stacked arrangement) within a housing 13 of the battery module 12. Each of the plurality of battery cells 20 has a similar or the same shape. Each of the plurality of battery cells 20 has an elongated plane surface parallel to an axis L. Each of the battery cells 20 has a prismatic shape, which is, in the schematic sectional view of FIG. 2, represented by a rectangle, which represents a cross-section of the respective battery cells 20. The stacked arrangement of the battery cells 20 indicates that the battery cells 20 are arranged so that the plane elongated surfaces of the battery cells 20 are parallel to each other and that the battery cells 20 are aligned with each other. For example, the battery cells 20 are assembled (or arranged) perpendicular to the axis L and in a straight line in the battery module 12.

The housing 13 of the battery module 12 includes a removable housing section 14, which may be, in some embodiments, referred to as a bottom plate. Thus, the removable housing section 14 is arranged perpendicular to the elongated surfaces of the battery cells 20 and to the axis L. In the embodiment, a longitudinal direction (e.g., the X direction in FIG. 2) of the removable housing section 14 is perpendicular to the axis L.

The battery module 12 includes the battery management arrangement 21 arranged within the housing 13. The battery management arrangement 21 includes a battery management housing 23 provided between the battery cells 20. The battery management housing 23 has a shape that is similar to or the same as the shape of the battery cells 20. The battery management housing 23 has an elongated plane surface parallel to the axis L. The battery management housing 23 has a prismatic shape that matches (e.g., is similar to or the same as) the prismatic shape of the battery cells 20 and that is, in the schematic sectional view of FIG. 2, represented by a rectangle, which represents a cross-section of the battery management housing 23. The battery management arrangement 21 is arranged in a stacked manner within the housing 13. The stacked arrangement of the battery management arrangement 21 indicates that the battery management housing 23 is arranged so that the elongated plane surface of the battery management housing 23 is parallel to and aligned with the battery cells 20. Thus, the removable housing section 14 is arranged perpendicular to the elongated surfaces of the battery management housing 23 and to the axis L.

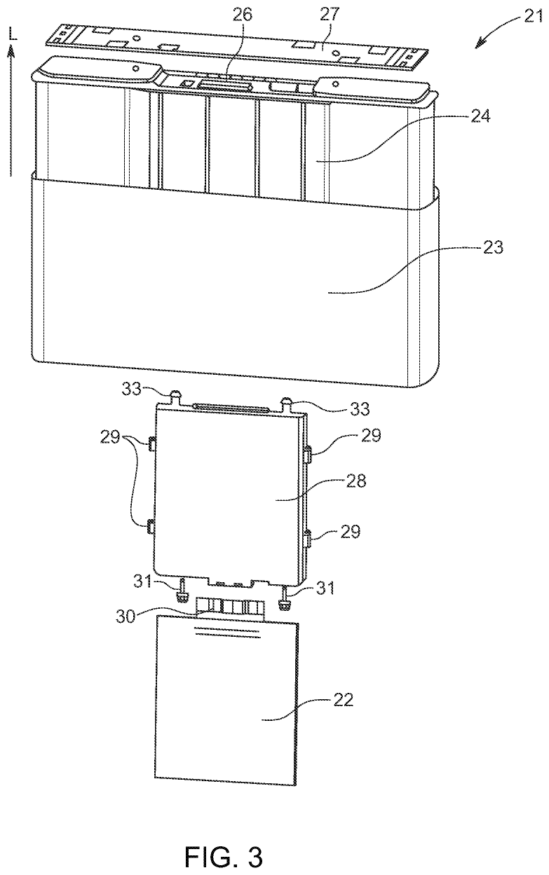

FIG. 3 is an exploded view of the battery management arrangement 21 as shown schematically in FIG. 2.

The battery management housing 23 has a prismatic shape that allows for a stacked arrangement with the battery cells 20 as described with reference to FIG. 2. The battery management housing 23 is, in one embodiment, a structural steel encasing, for example, a housing of the battery management arrangement 21 that is structurally and/or geometrically configured to enable the battery management arrangement 21 to be stacked into the battery module 12 as if it were one of the battery cells 20. The battery management housing 23 is made of metal. The battery management housing 23 may be made of sheet metal with a thickness of about 2 mm.

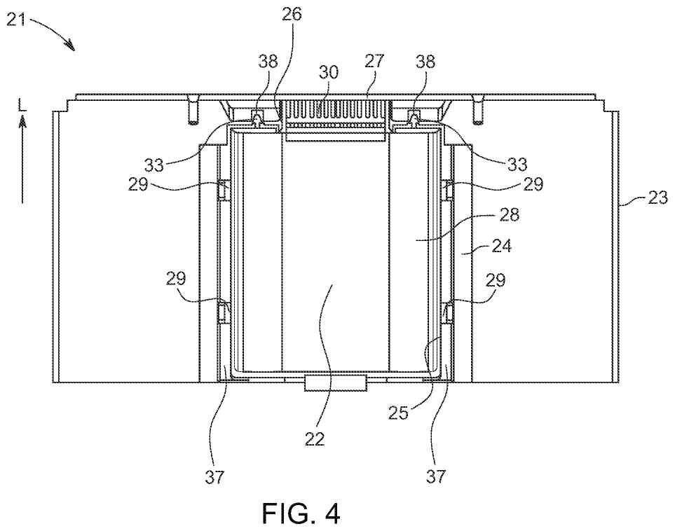

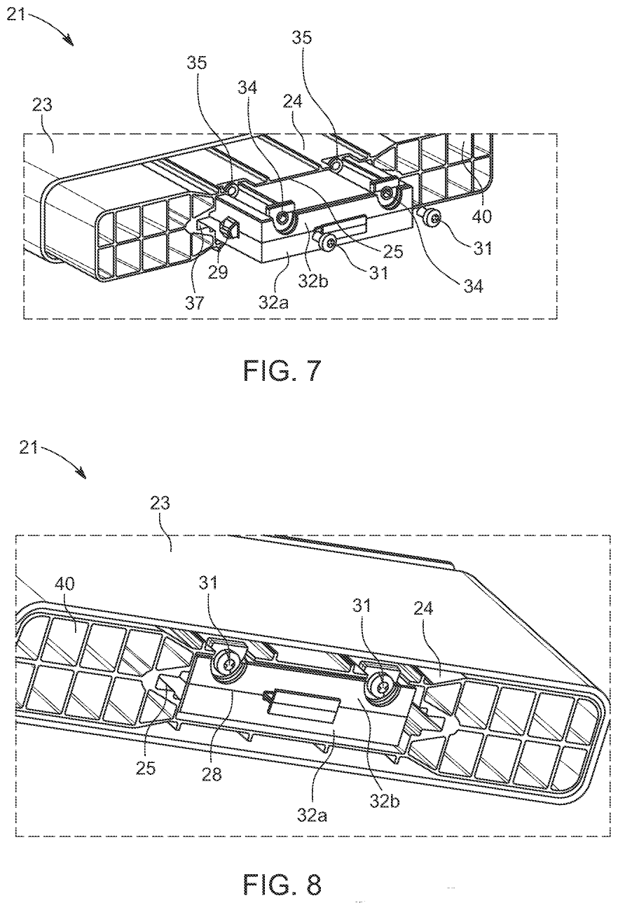

The battery management arrangement 21 includes a bracket 24 arranged within the battery management housing 23 and configured to retain a battery management module (BMM) 22. The bracket 24 is assembled into the battery management housing 23, for example, the structural steel encasing. The bracket 24 is made of a polymer, for example, the bracket 24 may be a plastic bracket. The bracket 24 has an opening 25 to retain the BMM 22 (see, e.g., FIGS. 7 and 8, the sectional side view of FIG. 4, and the description thereof). The bracket 24 defines an axis L along which the BMM 22 is slidably insertable in (or into) the bracket 24 to be retained (see, e.g., FIGS. 7 and 8 and the description thereof below).

The battery management housing 23 also defines an axis L along which the bracket 24 is slidably insertable in (or into) the battery management housing 23. The axis L is perpendicular to the longitudinal direction (X) of the removable housing section 14 of the battery module 12.

The axis L as described with reference to FIG. 2, and the axes L defined by the battery management housing 23 and by the bracket 24, coincide (or are the same).

The battery management arrangement 21 includes the BMM 22.

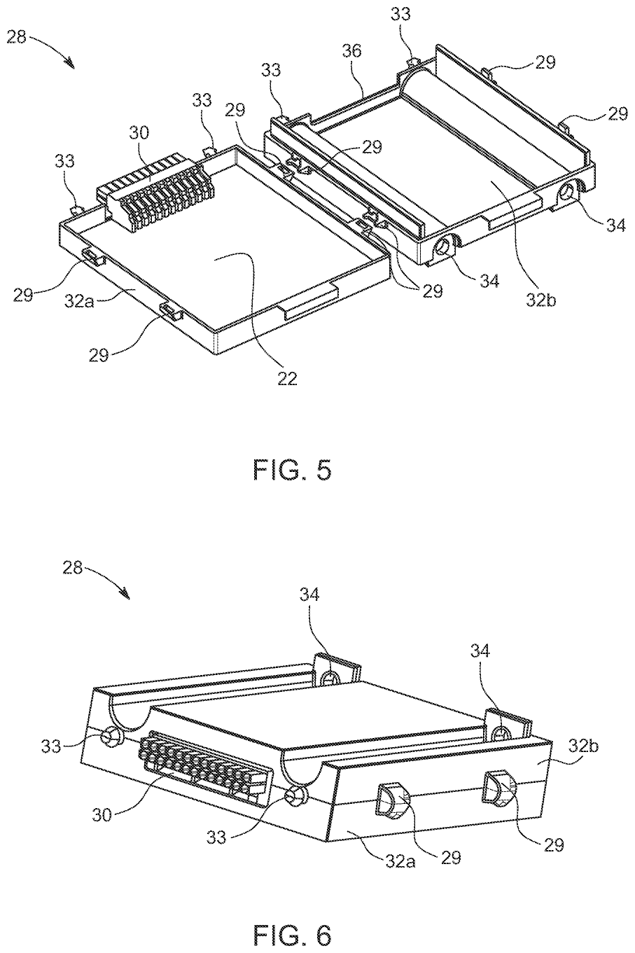

To arrange and retain the BMM 22 within the battery management housing 23, the battery management arrangement 21 includes an encasing 28 removably arranged within the bracket 24 as shown in, for example, FIGS. 7 and 8 and described with reference thereto, and configured to retain the BMM 22 as shown in, for example, FIGS. 5 and 6 and described with reference thereto. The encasing 28 includes a plurality of encasing fasteners 31 and a plurality of encasing clip arrangements 33 to removably fasten the encasing 28 within the bracket 24. The encasing 28 includes a plurality of guide members 29 arranged to guide the encasing 28 during insertion into the bracket 24 (see, e.g., FIGS. 7 and 8 and the description thereof). The BMM 22 is fixed within the insulating plastic encasing 28, which is further described with reference to, for example, FIGS. 5 and 6 below.

The battery management arrangement 21 includes an electronics arrangement 27 mounted to the bracket 24. The electronics arrangement 27 is a printed circuit board collector plate screwed onto the bracket 24 and configured to electrically interconnect the battery cells 20 with the BMM 22 and/or configured to electrically interconnect the BMM 22 with a BMM of another battery module 12 of the battery pack 10.

The bracket 24 includes at least one connector casing 26. The connector casing 26 may be integrally formed (e.g., molded) with the bracket 24. The BMM 22 includes a connector 30 provided within the connector casing 26 to interconnect the BMM 22 and the electronics arrangement 27.

The battery module 12 is assembled by providing the housing 13, which includes the removable housing section 14, the plurality of battery cells 20 accommodated within the housing 13, and a battery management arrangement 21 including the BMM 22, the battery management housing 23, and the electronics arrangement 27. The battery management housing 23 is arranged within the housing 13 of the battery module 12 between at least two of the plurality of battery cells 20 during stacking. The BMM 22 is arranged with the encasing 28 in the bracket 24, which is arranged within the battery management housing 23.

The complete super spacer assembly, that is, the battery management arrangement 21, is installed between the battery cells 20 during cell stacking. Wiring, such as a flat flex cable (FFC) may electrically connect the battery cells 20 and the BMM 22 and may be welded on top of the electronics arrangement 27 and/or the connector 30. Cell voltage, NTC signals, and daisy chain signals are connected to the BMM 22 via the connector 30, which is a so-called BMM quick connector provided in the connector casing 26. The electronics arrangement 27 may be referred to as an adapter plate. The main connection between each super spacer of the battery modules 12 (e.g., each of the battery management arrangements 21) is achieved by, for example, a welded FFC.

FIG. 4 is a sectional side view of the battery management arrangement 21 as shown in FIGS. 2 and 3.

FIG. 4 shows the battery management arrangement 21 in the mounted state. The bracket 24 is arranged within the battery management housing 23. The bracket 24 has the opening 25, in which the encasing 28 encasing the BMM 22 is arranged.

The encasing 28 includes the plurality of guide members 29 and an encasing clip arrangement 33 to fasten the encasing 28 within the bracket 24. The bracket 24 includes a complementary guide and/or fastening arrangement. For example, the encasing 28 includes a plurality of protrusions as guide members 29, and the bracket 24 includes a plurality of recesses, such as a bracket recess 37 in the opening 25, as a complementary guide arrangement. The encasing 28 includes a plurality of pin-shaped clips as encasing clip arrangements 33, and the bracket 24 includes a clip-receiving recess 38 to receive the clips of the encasing clip arrangements 33 in a locking manner to retain the encasing 28 in the bracket 24. Additionally, the encasing 28 has an encasing opening (or encasing through-hole) 34, and the bracket 24 has a bracket opening (or bracket hole) 35 as a complementary fastening arrangement to receive the encasing fasteners 31, such as screws to fix the encasing 28 to the bracket 24, as further described with reference to, for example, FIGS. 7 and 8. The encasing fasteners 31, the encasing clip arrangements 33, and, optionally, the complementary fastening arrangement of the bracket 24, are configured to retain the encasing 28 and, thus, the BMM 22 removably within the battery management housing 23. Accordingly, the BMM 22 can be reversibly removed from the battery management arrangement 21 by removing the encasing 28 so that the BMM 22 and the encasing 28 can be inserted in the battery management arrangement 21 later again, for example, after servicing the BMM 22, to the retained battery management arrangement 21.

FIG. 5 is a perspective view of an opened encasing 28, including the battery management module (BMM) 22, according to an embodiment. FIGS. 5 and 6 illustrate how, according to an embodiment, the BMM 22 and the encasing 28 are mechanically interconnected.

The encasing 28 includes two encasing sections 32a, 32b, between which the BMM 22 is arranged. The encasing sections 32a, 32b form a bipartite encasing 28. The encasing 28 has a connector opening 36 through which the connector 30 of the BMM 22 is accessible from an exterior of the encasing 28.

The encasing 28 includes a plurality of guide members 29 for guiding the encasing 28 during insertion into the bracket 24 as explained with reference to, for example, FIGS. 7 and 8. Each of the encasing sections 32a, 32b includes a part of each of the guide members 29. In the mounted (or closed) state (as shown in, for example, FIG. 6), the parts of the guide members 29 come together to form the guide members 29. The parts of the guide members 29 can be used to open and/or close the encasing 28 with a clip mechanism. For example, the parts of the guide members 29 on the encasing section 32a are complementary to the parts of the guide members 29 on the encasing section 32b so that the encasing sections 32a, 32b can be clipped together to close the encasing 28.

The encasing 28 has two encasing openings (or encasing through-holes) 34 for receiving an encasing fastener 31 as explained with reference to, for example, FIGS. 7 and 8.

The encasing 28 includes two encasing clip arrangements 33 to fasten the encasing 28 to the bracket 24. For example, the encasing 28 includes two projections forming pin-shaped members as encasing clip arrangements 33. Each of the encasing sections 32a, 32b includes a part of each of the encasing clip arrangements 33. In the mounted (or closed) state (as shown in, for example, FIG. 6), the parts of the encasing clip arrangements 33 together form the encasing clip arrangements 33.

The BMM 22 can be arranged within the encasing 28 in a locking manner, for example, the BMM 22 can be clamped and/or fixed in the encasing 28. Alternatively or additionally, BMM 22 can be fastened within the encasing 28 by a fastening device, such as one or more screws, bolts, press-fit pins, and/or an adhesive.

FIG. 6 is a perspective view of the encasing 28, including the battery management module (BM) 22, in a closed state according to the embodiment shown in FIG. 5. The encasing section 32a, 32b are clipped together by the guide members 29 with the complementary parts thereof as described with reference to, for example, FIG. 5. The parts of the encasing clip arrangements 33 as described with reference to, for example, FIG. 5 together form the encasing clip arrangements 33.

FIG. 7 is a perspective view of the battery management arrangement 21 as described with reference to FIGS. 3 and 4. FIG. 7 and FIG. 8 illustrate how the encasing 28, as described with reference to, for example, FIGS. 5 and 6, and the bracket 24 are mechanically interconnected.

The encasing 28, together with the BMM 22, as shown in, for example, FIG. 6 is slidably inserted into the opening 25 in the bracket 24. The opening 25 is shaped to have a bracket recess 37 complementary to the guide members 29. The guide members 29 guide the encasing 28 during insertion into the bracket 24.

The bracket 24 has two bracket openings (or bracket holes) 35, each receiving an encasing fastener 31. For example, the encasing fastener 31 may be a screw or a bolt. Each of the bracket openings 35 may be a through-hole or a blind hole provided by (or in) the bracket 24. Each of the bracket openings 35 may include a thread to engage with the encasing fastener 31 (see, e.g., FIG. 8). Each of the bracket openings 35 and each of the encasing openings 34 may include metal inserts to enable a stable threaded connection.

The bracket 24 has hollow spaces 40 to provide a light weight and mechanically stable construction.

FIG. 8 is a perspective view of the battery management arrangement 21 in the mounted state according to the embodiment shown in FIG. 7.

The bracket 24 is retained within the battery management housing 23. The encasing 28, with the BMM 22, is retained in the bracket 24. The encasing 28 is mounted in a fixed and reversible manner to the bracket 24 by the encasing fasteners 31. The encasing 28 is directly screwed to the bracket 24, for example, the encasing fasteners 31 are arranged to extend through the encasing openings 34 and through or into the corresponding bracket openings 35.

### SOME REFERENCE NUMERALS

10 battery pack
12 battery module
13 housing
14 housing section
20 battery cell
21 battery management arrangement
22 battery management module (BMM)
23 battery management housing
24 bracket
25 opening
26 connector casing
27 electronics arrangement
28 encasing
29 guide member
30 connector
31 encasing fastener
32a, 32b encasing section
33 encasing clip arrangement
34 encasing through hole
35 bracket hole
36 connector opening
37 bracket recess
38 clip-receiving recess
40 hollow space
300 vehicle
301 interconnects
310 motor
L axis

What is claimed is:

1. A battery module comprising:
a housing comprising a removable housing section;
a plurality of battery cells accommodated within the housing; and
a battery management arrangement comprising:
a battery management module (BMM);
a battery management housing comprising a bracket retaining the BMM, the battery management housing being in the housing and between two of the battery cells; and
an electronics arrangement.

2. The battery module according to claim 1, wherein the battery management arrangement further comprises an encasing removably arranged within the bracket and retaining the BMM.

3. The battery module according to claim 2, wherein the encasing comprises a plurality of encasing sections, the BMM being accommodated therebetween.

4. The battery module according to claim 2, wherein the encasing comprises an encasing fastener and/or an encasing clip arrangement to fasten the encasing to the bracket.

5. The battery module according to claim 1, wherein the electronics arrangement is mounted to the bracket.

6. The battery module according to claim 1, wherein the battery management housing comprises metal, and the bracket comprises a polymer.

7. The battery module according to claim 1, wherein the battery management housing comprises sheet metal having a thickness in a range between 1.8 mm and 2.2 mm.

8. The battery module according to claim 1, wherein the battery management housing defines an axis along which the bracket is slidably insertable into the battery management housing.

9. The battery module according to claim 8, wherein the axis is perpendicular to a longitudinal direction of the removable housing section.

10. The battery module according to claim 1, wherein the bracket defines an axis along which the BMM is slidably insertable into the bracket.

11. The battery module according to claim 10, wherein the axis is perpendicular to a longitudinal direction of the removable housing section.

12. The battery module according to claim 1, wherein the bracket has an opening configured to retain the BMM.

13. The battery module according to claim 1, wherein the bracket comprises a connector casing, and
wherein the BMM comprises a connector within the connector casing to interconnect the BMM and the electronics arrangement.

14. A battery pack comprising a plurality of the battery modules as claimed in claim 1.

15. An electric vehicle comprising the battery module according to claim 1 and/or the battery pack according to claim 14.

16. A battery management arrangement comprising:
a battery management module (BMM);
a battery management housing comprising a bracket retaining the BMM; and
an electronics arrangement.

17. A method for assembling the battery module according to claim 1, the method comprising:
arranging the battery management housing within the housing and between two of the battery cells; and
arranging the BMM in the bracket arranged within the battery management housing to retain the BMM.
